(19) United States
(12) Patent Application Publication
(10) Pub. No.: US 2014/0063387 A1
(43) Pub. Date: Mar. 6, 2014

(54) Blue Phase Liquid Crystal Display Panel, Blue Phase Liquid Crystal Display Device And Driving Method Thereof

(71) Applicant: BOE Technology Group Co., Ltd., Beijing (CN)

(72) Inventor: Xin Gu, Beijing (CN)

(73) Assignee: BOE Technology Group Co., Ltd., Beijing (CN)

(21) Appl. No.: 13/995,025

(22) PCT Filed: Oct. 24, 2012
(86) PCT No.: PCT/CN2012/083449

§ 371 Date: Jun. 17, 2013

(30) Foreign Application Priority Data
Jun. 16, 2012 (CN) 201210208336.8

(51) Int. Cl. G02F 1/1343

(52) U.S. Cl. CPC G02F 1/134309
USPC 349/33; 349/106

(57) ABSTRACT

A blue phase liquid crystal display panel and a blue phase liquid crystal display are disclosed. The blue phase liquid crystal display panel comprises an array substrate (12) and a color filter substrate (15) opposed to each other, and blue phase liquid crystal molecules (14) arranged between the array substrate (12) and the color filter substrate (15). A plurality of the first common electrodes (171) in strip shape and a plurality of pixel electrodes (13) in strip shape are alternately arranged on the array substrate (12), and there is interval between the first common electrode (171) and the pixel electrode (13) in adjacent; a plurality of the second common electrodes (172) in strip shape are arranged on the color filter substrate (15), wherein each of the second common electrodes (172) is disposed opposite to one of the first common electrodes (171). Since the electric field between the array substrate (12) and the color filter substrate (15) are formed as a result of the cooperation effects of the pixel electrodes (13), the first common electrodes (171) and the second common electrodes (172), the electric field formed between the array substrate (12) and the color filter substrate (15) can have a more uniform intensity; it only needs to apply a lower potential difference across the pixel electrodes (13) and the first common electrodes (171) as well as the second common electrodes (172) when driving the panel.

### TECHNICAL FIELD

Embodiments of the present invention relate to a blue phase liquid crystal display panel and a blue phase liquid crystal display device.

### BACKGROUND

Polymer stabilized blue phase liquid crystal display panels have the characteristics of fast response speed (which is 10 times to the response rate of ordinary nematic liquid crystals), without the need for liquid crystal alignment layer, etc., and therefore attract wide attentions. However, the blue phase liquid crystal display panel in the state of art has been difficult to be commercialized because of the defects of high driving voltage, low light transmission etc.

FIG. 1 is a principle schematic diagram of the blue phase liquid crystal display panel with the electrode structure of conventional In-plane switching (IPS) display technology.

The blue phase liquid crystal display panel with the conventional IPS electrode structure comprises: the array substrate 2, the pixel electrode 3 and the common electrode 1 disposed on the array substrate 2 and distributed apart from each other, the color filter substrate 5, and the blue phase liquid crystal molecules 4 between the array substrate 2 and the color filter substrate 5. When a voltage is applied to the pixel electrode 3 and the common electrode 1, the electric field 7 is generated in the liquid crystal layer.

The birefringence of the blue phase liquid crystal molecules 4 is induced from the driving of the electric field. The blue phase liquid crystal molecules 4 deform along the direction of the electric field 7, and their optical axes extend along the direction of the electric field of 7. Depending on the different direction of the electric field 7, the degree of anisotropy of blue phase liquid crystal molecules is also different.

In the blue phase liquid crystal display panel with the conventional IPS electrode structure, farther from the array substrate 2, the intensity of the electric field generated between the pixel electrode 3 and the common electrode 1 is smaller. When the voltage for generating the electric field 7 is applied to the pixel electrode 3 and the common electrode 1, the blue phase liquid crystal molecules 42 of the lower layer closed to the array substrate 2 will gain more power, and can twist and deform quickly, and their amount of deformation is large, and light transmissivity is high. However, the blue phase liquid crystal molecules 41 of the upper layer far from the array substrate 2 cannot obtain the same power, so they move slowly, and the amount of deformation is smaller and the light transmissivity is lower, as shown in FIG. 1. Owing to these blue phase liquid crystal molecules 42, the light transmissivity of the entire blue phase liquid crystal molecules 4 is affected, which results in a lower light transmission of the conventional blue phase liquid crystal panel. The only way to make the blue phase liquid crystal molecules 41 of the upper layer far from the array substrate 2 gain enough power is to increase the driving voltage between the pixel electrode 3 and the common electrode 1, thus higher driving voltage is necessary.

Accordingly, there is a need in the art to provide a blue phase liquid crystal display panel and a blue phase liquid crystal display device with lower driving voltage and improved light transmission.

### SUMMARY

The embodiments of the present invention provide a blue phase liquid crystal display panel and a blue phase liquid crystal display device in order to solve the problems of high driving voltage and low light transmission in blue phase liquid crystal display panels of prior art.

In one aspect, the present invention provides a blue phase liquid crystal display panel, it comprises: a color filter substrate and an array substrate disposed opposite to each other, and blue phase liquid crystal molecules arranged between the array substrate and the color filter substrate, wherein a plurality of first common electrodes in strip shape and a plurality of pixel electrodes in strip shape are alternately arranged on the array substrate, and there is interval between the first common electrode and the adjacent pixel electrode; a plurality of second common electrodes in strip shape are arranged on the color filter substrate, wherein each of the second common electrodes is disposed opposite to one of the first common electrodes.

In the blue phase liquid crystal display panel, for instance, the pixel electrodes and the first common electrodes are alternately and evenly distributed on the array substrate, and the interval has a predetermined value.

In the blue phase liquid crystal display panel, for instance, the width of the pixel electrodes, the first common electrodes and the second common electrodes has a same predetermined value.

In the blue phase liquid crystal display panel, for instance, the predetermined value of the width is 1-4 μm, the predetermined value of the interval is 3-8 μm.

In the blue phase liquid crystal display panel, for instance, the predetermined value of the width is 1.6 μm, the predetermined value of the interval is 4.4 μm.

Based on the above technical solutions, in another aspect, the present invention also provides a blue phase liquid crystal display device, the device comprises the blue phase liquid crystal display panel according to any one of the above technical solutions.

In yet another aspect, the present invention also provides a driving method for a blue phase liquid crystal display device, the blue phase liquid crystal display device comprising the blue phase liquid crystal display panel according to any one of the above technical solutions. The method comprises: applying a driving signal voltage to the pixel electrodes, and applying a common voltage to the first common electrodes and the second common electrodes.

In the blue phase liquid crystal display panel provided by the embodiments of the present invention, the pixel electrodes and the first common electrodes are disposed on the array substrate, and the second common electrodes are disposed on the color filter substrate, since the electric field between the array substrate and the color filter substrate are formed as a result of the cooperation effects of the pixel electrodes, the first common electrodes and the second common electrodes, the electric field formed between the array substrate and the color filter substrate can have a more uniform intensity. At the same time, compared to the blue phase liquid crystal display panel with the conventional IPS electrode structure mentioned in the BACKGROUND, in the blue phase liquid crystal display panel of the embodiments of the present invention, it only needs to apply a lower potential difference across the pixel electrodes and the first common electrodes as well as the second common electrodes. Therefore, the blue phase liquid crystal display panel provided by the embodiments of the present invention has lower driving voltage, and its light transmission can be improved.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a principle schematic diagram of a blue phase liquid crystal display panel with conventional IPS electrode structure;

FIG. 2 is a structural diagram of pixel electrodes, first and second common electrodes in a blue phase liquid crystal display panel provided by an embodiment of the present invention in power-off state;

FIG. 3 is a structural diagram of pixel electrodes, first and second common electrodes in a blue phase liquid crystal display panel provided by an embodiment of the present invention in power-on state.

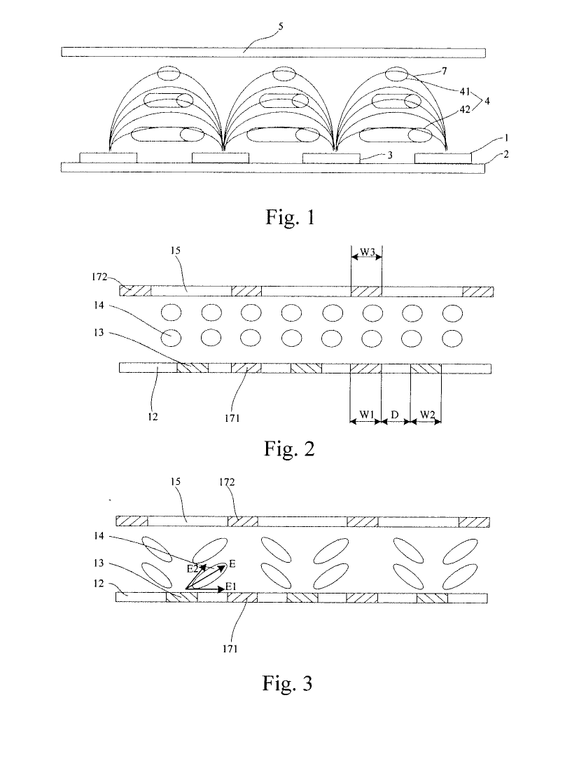

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at lease one. The phrases “connect”, “connected”, etc., are not intended to define a physical connection or mechanical connection, but may include an electrical connection, directly or indirectly. “On,” “under,” “right,” “left” and the like are only used to indicate relative position relationships, and when the position of the object which is described is changed, the relative position relationship may be changed accordingly.

As shown in FIG. 2, a blue phase liquid crystal display panel provided by an embodiment of the present invention comprises: an array substrate 12 and a color filter substrate 15 disposed opposite to each other, and blue phase liquid crystals 14 arranged between the array substrate 12 and the color filter substrate 15. The blue phase liquid crystals may use, e.g., polymer-stabilized blue phase liquid crystals, blue phase liquid crystals with dimesogenic liquid crystals, or the like.

The blue phase liquid crystal display panel of the present embodiment comprises a plurality of pixels. These pixels may be arranged in a matrix. The following description may be made with regard to a single or a plurality of pixel(s). The blue phase liquid crystal display panel may further comprise gate lines and data lines so as to define these pixels. For instance, the liquid crystal panel may be in a form of active driving, each pixel may comprise, e.g. a thin film transistor (TFT) functioning as a switching element.

The blue phase liquid crystal display panel further comprises: a plurality of first common electrodes 171 in strip shape and a plurality of pixel electrodes 13 in strip shape, and a plurality of second common electrodes 172 in strip shape. The first common electrodes 171 and the pixel electrodes 13 are alternately arranged on the array substrate 12, and there is a certain interval D between the adjacent first common electrode 171 and the pixel electrode 13. A plurality of the second common electrodes 172 are arranged on the color filter substrate 15, wherein each of the second common electrodes 172 is disposed opposite to the respective one of the first common electrodes 171, that is, they are disposed face to face.

In order to describe conveniently, it is assumed that the array substrate 12 of the blue phase liquid crystal display panel is disposed horizontally and also located under the color filter substrate 15.

FIG. 3 is a structural diagram of the pixel electrodes, the first common electrodes and second common electrodes in the blue phase liquid crystal display panel provided by the present embodiment in a power-on state. The pixel electrodes 13, the first common electrodes 171 and second common electrodes 172 provided in the present embodiment are all in strip shape. After powering on, i.e. applying a driving signal voltage (e.g. from the data line) on the pixel electrode 13 and applying a common voltage (e.g. 0V or grounding) on the first common electrode 171 and the second common electrode 172, a horizontal electric field E1 is generated between the pixel electrode 13 and the adjacent the first common electrode 171. The direction of the electric field of E1 is from the pixel electrode 13 to the first common electrode 171. At the same time, an electric field E2 is generated between the pixel electrode 13 and the second common electrode 172 disposed on the color filter substrate 15 and opposite to the first common electrode 171. The direction of the electric field E2 inclines upward from the pixel electrode 13 to the second common electrode 172. The direction of the resultant electric field E formed by the horizontal electric field E1 and the inclined upward electric field E2 is the direction of the final electric field. Therefore, the blue phase liquid crystal molecule 14 deforms along the direction of resultant electric field E, and its optical axis extends along the direction of resultant electric field E. In the blue phase liquid crystal display panel provided by the present embodiment, because the pixel electrodes 13 and the first common electrodes 171 are disposed on the array substrate 12, while the second common electrodes 172 are disposed on the color filter substrate 15, the electric field between the array substrate 12 and the color filter substrate 15 is formed as a result of the cooperation effect of the pixel electrodes 13 and the first common electrodes 171 as well as the second common electrodes 172, which can make the electric field formed between the array substrate 12 and the color filter substrate 15 have more uniform intensity.

In addition, compared to the blue phase liquid crystal display panel with conventional IPS mode mentioned in the BACKGROUND, it is only needed to apply lower voltage to the pixel electrodes 13, the first common electrodes 171 and the second common electrodes 172 for driving the blue phase liquid crystal display panel provided by the present embodiments. Therefore, the blue phase liquid crystal display panel provided by the present embodiment has lower driving voltage, and its light transmission can be improved.

Further, in order to enhance the uniformity of the electric field between the array substrate 12 and the color filter substrate 15, it is preferred that the pixel electrodes 13 and the first common electrodes 171 are alternately and evenly distributed on the array substrate 12, and the interval between the adjacent first common electrode 171 and pixel electrode 13 has a predetermined value.

As shown in FIG. 2, based on the above technical solution, the width of the first common electrode 171 is set as W1, the width of the pixel electrode 13 is set as W2, and the width of the second common electrode 172 is W3. W1, W2 and W3 may be same or different from each other. In order to enhance the uniformity of the electric field between the array substrate 12 and the color filter substrate 15, it is preferred that the widths W1, W2 and W3 are same to each other and have a predetermined value.

Specifically, after many experiments, the applicants finds that in case that the predetermined value of the width W1 of the first common electrode 171, the width W2 of the pixel electrode 13 and the width W3 of the second common electrode 172 is 1-4 μm, and at the same time the interval D between the adjacent pixel electrode 13 and the first common electrode 171 is 3-8 μm, both the intensity and the uniformity of the resultant electric field E can be improved notably.

For instance, the predetermined value of the width W1 of the first common electrode 171, the width W2 of the pixel electrode 13 and the width W3 of second common electrode 172 is 1.6 μm preferably, and the interval D between the adjacent pixel electrode 13 and the first common electrode 171 is 4.4 μm preferably.

The embodiment of the present invention also provides a blue phase liquid crystal display device comprising the blue phase liquid crystal display panel in any of aforementioned embodiments. The blue phase liquid crystal display device may be used for liquid crystal television, laptop computer, GPS, mobile phones, tablet computer and the like.

What are described above is related to the illustrative embodiments of the disclosure only, and not limitative to the scope of the disclosure, the scopes of the disclosure are defined by the accompanying claims.

1. A blue phase liquid crystal display panel, comprising a color filter substrate and an array substrate disposed opposite to each other, and blue phase liquid crystal molecules arranged between the array substrate and the color filter substrate,
wherein a plurality of first common electrodes in strip shape and a plurality of pixel electrodes in strip shape are alternately arranged on the array substrate, and there is interval between the first common electrode and the adjacent pixel electrode;
a plurality of second common electrodes in strip shape are arranged on the color filter substrate, wherein each of the second common electrodes is disposed opposite to one of the first common electrodes.

2. The blue phase liquid crystal display panel according to claim 1, wherein the pixel electrodes and the first common electrodes are alternately and evenly distributed on the array substrate, and the interval has a predetermined value.

3. The blue phase liquid crystal display panel according to claim 2, the width of the pixel electrodes, the first common electrodes and the second common electrodes has a same predetermined value.

4. The blue phase liquid crystal display panel according to claim 3, wherein the predetermined value of the width is 1-4 μm, the predetermined value of the interval is 3-8 μm.

5. The blue phase liquid crystal display panel according to claim 4, wherein the predetermined value of the width is 1.6 μm, the predetermined value of the interval is 4.4 μm.

6. A blue phase liquid crystal display device, comprising the blue phase liquid crystal display panel according to claim 1.

7. A driving method for a blue phase liquid crystal display device, the blue phase liquid crystal display device comprising the blue phase liquid crystal display panel according to claim 1, the method comprising:
applying a driving signal voltage to the pixel electrodes, and applying a common voltage to the first common electrodes and the second common electrodes.
